(19) United States
(12) Patent Application Publication
(10) Pub. No.: US 2008/0221834 A1
(43) Pub. Date: Sep. 11, 2008

(54) METHOD AND SYSTEM FOR ENHANCED FAULT DETECTION WORKFLOW

(75) Inventor: Gopinath Damodharan, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/684,222

(22) Filed: Mar. 9, 2007

(51) Int. Cl. G06F 11/34

(52) U.S. Cl. 702/183; 235/375; 235/487

(57) ABSTRACT

A method for fault detection workflow management is presented. The method includes determining a working environment, a rule application attribute, or both, where the working environment and the rule application attribute are associated with input data. Furthermore, the method includes dynamically optimizing a sequence of operations based on the determined working environment, the determined rule application attribute, or both. Additionally, the method includes processing the input data based on the optimized sequence of operations. Systems and computer-readable medium that afford functionality of the type defined by this method is also contemplated in conjunction with the present technique.

### BACKGROUND

The invention relates generally to diagnosis of system status, and more particularly to methods and systems for fault detection.

Diagnostic imaging systems have emerged into an essential aspect of patient care. Medical images that are obtained via the diagnostic imaging sessions have evolved as tools that allow a clinician non-invasive means to view anatomical cross-sections of internal organs, tissues, bones and other anatomical regions of a patient. As will be appreciated, medical images may be obtained from a broad spectrum of imaging modalities, such as, but not limited to computed tomography (CT) imaging, ultrasound imaging, magnetic resonance (MR) imaging, digital mammography, X-ray imaging, nuclear medicine imaging, or positron emission tomography (PET) imaging, or combinations of the above.

As will be appreciated, it is desirable to reduce and/or prevent downtime of the diagnostic imaging systems. Customer satisfaction may be enhanced and maintenance costs reduced when problems with systems, such as, but not limited to, imaging systems, may be diagnosed and fixed before the problems become serious enough to warrant extended downtime of the diagnostic imaging system. Typically, a field service technician may perform a set of diagnostic routines to attempt to isolate a source of a malfunction and/or to evaluate the status of the diagnostic imaging system, where the diagnostic routines may be reactive or proactive. It may be noted that these diagnostic routines are run to facilitate reduction in customer observed downtime i.e., from unplanned downtime to planned downtime and also to improve service engineering productivity. Furthermore, running the set of diagnostic routines may involve analysis of log data generated by the diagnostic imaging system. However, the analysis of the large amount of data in these log files may inordinately lead to delays in fault detection, diagnosis and subsequent servicing of the diagnostic imaging system, and thereby adversely affect system availability.

A wide variety of techniques have been developed to aid in the diagnosis of diagnostic imaging systems. Conventional fault detection systems generally allow the diagnostic imaging systems to call for service automatically when sensors detect certain operating parameters outside of permissible ranges. In these conventional systems, telephone lines and modems are used by the devices to call a service center and report operating condition status and device usage data. A field service technician may then be dispatched to the site to perform a set of diagnostic routines to attempt to isolate a source of a malfunction. Unfortunately, use of these presently available techniques for fault detection results in diminished performance. Furthermore, these techniques are not scalable and hence result in additional setup costs.

It may therefore be desirable to develop a robust technique and system for the systematic detection of faults that advantageously facilitates substantially superior fault detection, diagnosis and service of the diagnostic imaging system. In particular, there is a need for a system that may be configured to aid in enhancing ease of detecting faults, thereby simplifying the maintenance workflow of the diagnostic imaging system.

### BRIEF DESCRIPTION

In accordance with aspects of the present technique, a method for fault detection workflow management is presented. The method includes determining a working environment, a rule application attribute, or both, where the working environment and the rule application attribute are associated with input data. Furthermore, the method includes dynamically optimizing a sequence of operations based on the determined working environment, the determined rule application attribute, or both. Additionally, the method includes processing the input data based on the optimized sequence of operations. Computer-readable medium that afford functionality of the type defined by this method is also contemplated in conjunction with the present technique.

In accordance with further aspects of the present technique, a detection system is presented. The system includes a workflow module having a workflow manager and configured to determine a working environment, a rule application attribute, or both, where the working environment and the rule application attribute are associated with input data, dynamically optimizing a sequence of operations based on the determined working environment, the determined rule application attribute, or both. In addition, the detection system includes a processing module configured to process the input data based on the optimized sequence of operations, where the processing module includes a pre-processor module configured to pre-process the input data based on one or more predefined rules, an interpreter module configured to interpret the pre-processed data based on the predefined rules, and a post-processing module configured to post-process the interpreted data.

In accordance with further aspects of the present technique, a system is presented. The system includes a data source, where the data source includes an acquisition subsystem configured to acquire data, and a processing subsystem in operative association with the acquisition subsystem and configured to process the acquired data, and generate log data. Additionally, the system includes a data storage subsystem configured to store the log data. The system also includes a detection subsystem in operative association with the data storage subsystem and configured to determine a working environment, a rule application attribute, or both, where the working environment and the rule application attribute are associated with input data, dynamically optimize a sequence of operations based on the determined working environment, the determined rule application attribute, or both, and process the log data based on the optimized sequence of operations.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary diagnostic system, in accordance with aspects of the present technique;

FIG. 2 is a block diagram of an imaging system in the diagnostic system of FIG. 1, in accordance with aspects of the present technique;

FIG. 3 is a block diagram of an exemplary detection system, in accordance with aspects of the present technique;

FIG. 4 is a block diagram of a portion of the exemplary detection system of FIG. 3, in accordance with aspects of the present technique;

FIG. 5 is a flow chart illustrating an exemplary transactional workflow of a process of fault detection, in accordance with aspects of the present technique;

FIG. 6 is a flow chart illustrating an exemplary process of fault detection workflow management, in accordance with aspects of the present technique; and

FIGS. 7A-7C are flow charts illustrating an exemplary process of fault detection workflow management based on a working environment, in accordance with aspects of the present technique;

FIGS. 8-10 are flow charts illustrating exemplary processes of fault detection workflow management based on a rule application attribute, in accordance with aspects of the present technique.

### DETAILED DESCRIPTION

As will be described in detail hereinafter, a method for fault detection workflow management and a system for detection configured to optimize a workflow for fault detection and simplify fault detection in a diagnostic imaging system, are presented. Employing the method and system described hereinafter, a generic, scalable, and configurable fault detection workflow framework may be obtained. This fault detection workflow framework may be configured to dramatically enhance fault detection in systems, thereby optimizing the performance of the detection system.

Although, the exemplary embodiments illustrated hereinafter are described in the context of a medical imaging system, it will be appreciated that use of the diagnostic system in industrial applications are also contemplated in conjunction with the present technique.

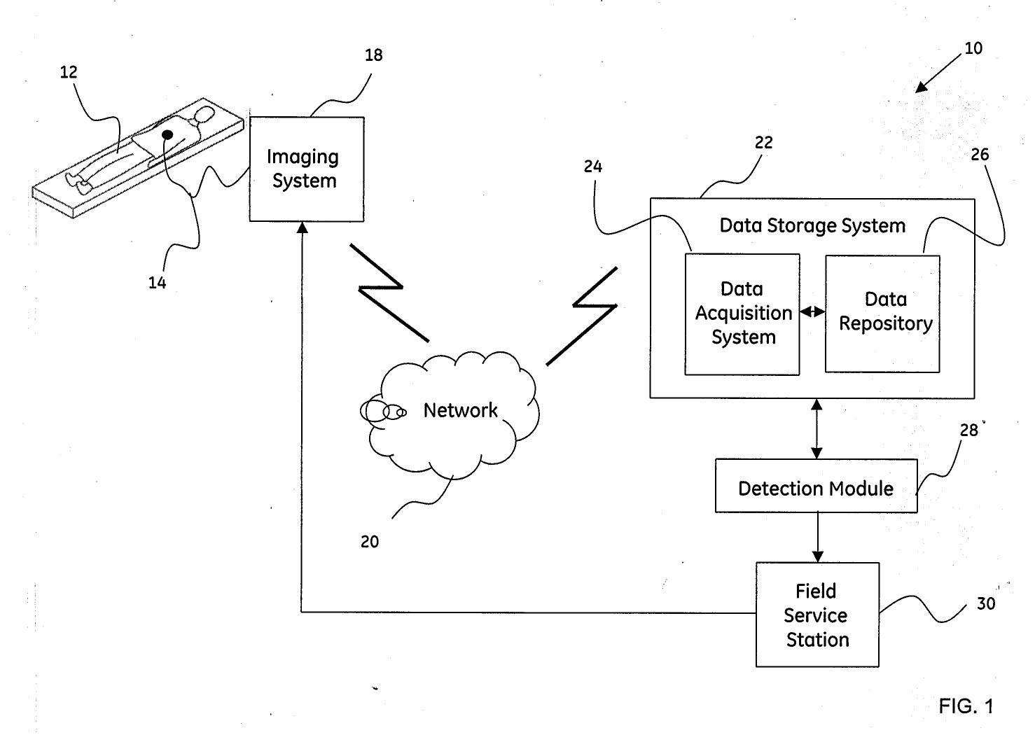

FIG. 1 is a block diagram of an exemplary system 10 for use in diagnostic imaging in accordance with aspects of the present technique. The system 10 may be configured to acquire image data from a patient 12 via an image acquisition device 14. In one embodiment, the image acquisition device 14 may include a probe, where the probe may include an invasive probe, or a non-invasive or external probe, such as an external ultrasound probe, that is configured to aid in the acquisition of image data. Also, in certain other embodiments, image data may be acquired via one or more sensors (not shown) that may be disposed on the patient 12. By way of example, the sensors may include physiological sensors (not shown) such as electrocardiogram (ECG) sensors and/or positional sensors such as electromagnetic field sensors or inertial sensors. These sensors may be operationally coupled to a data acquisition device, such as an imaging system, via leads (not shown), for example.

The system 10 may also include an imaging system 18 that is in operative association with the image acquisition device 14. In a presently contemplated configuration, the imaging system 18 may include a medical imaging system. It may be noted that although the present example illustrates the diagnostic system 10 as including one imaging system 18, the diagnostic system 10 may include more than one imaging system.

It should be noted that although the exemplary embodiments illustrated hereinafter are described in the context of a medical imaging system, other imaging systems and applications such as industrial imaging systems and non-destructive evaluation and inspection systems, such as pipeline inspection systems, liquid reactor inspection systems, are also contemplated. Additionally, the exemplary embodiments illustrated and described hereinafter may find application in multi-modality imaging systems that employ ultrasound imaging in conjunction with other imaging modalities, position-tracking systems or other sensor systems. Furthermore, it should be noted that although the exemplary embodiments illustrated hereinafter are described in the context of a medical imaging system, such as, but not limited to, an ultrasound imaging system, an optical imaging system, a computed tomography (CT) imaging system, a magnetic resonance (MR) imaging system, an X-ray imaging system, or a positron emission tomography (PET) imaging system, other imaging systems, such as, but not limited to, a pipeline inspection system, a liquid reactor inspection system, or other imaging systems are also contemplated in accordance with aspects of the present technique.

In addition to acquiring image data, the medical imaging system 18 may also be configured to generate one or more log files. As will be appreciated, a log file may be representative of a file that lists actions that have occurred. More particularly, the log file may include functions and activities performed by the imaging system, often in a time-associated format, for example. Furthermore, the log file may include data representative of events, errors, machine critical parameters, sensor outputs, or a combination thereof. Also, the log file may include machine-readable data.

As will be appreciated, the image data acquired via the medical imaging system 18 may be stored in a database, for example. Additionally, the log files may be communicated to a first storage 22. In a presently contemplated configuration, the first storage 22 may include a data storage system. Also, in one embodiment, the data storage system 22 may be at a location that is physically remote from the location of the medical imaging system 18. However, as will be appreciated, in certain embodiments, the data storage system 22 may be disposed in substantially close proximity to the imaging system 18. Moreover, in one embodiment, the image data may be communicated to the data storage system 22 via a network 20.

Additionally, the one or more log files may also be communicated to the data storage system 22 via the network 20. It may be noted that other means of communication, such as, but not limited to, the Internet, the intranet, or wireless communication may also be employed to transmit the log files from the medical imaging system 18 to the data storage system 22. Furthermore, in one embodiment, the one or more log files may be transmitted to the data storage system 22 in real-time. Alternatively, the one or more log files communicated to the data storage system 22 may be temporarily stored in a temporary storage and communicated to the data storage system 22 at a later time.

In addition, the data storage system 22 may include a data acquisition subsystem 24 that may be configured to receive the log files transmitted from the medical imaging system 18 via the network 20. The log files received by the data acquisition system 24 may be stored in a data repository 26. In one embodiment, the data repository 26 may include an archival site, a database, or an optical data storage article. It may be noted that the optical data storage article may be an optical storage medium, such as a compact disc (CD), a digital versatile disc (DVD), multi-layer structures, such as DVD-5 or DVD-9, multi-sided structures, such as DVD-10 or DVD-18, a high definition digital versatile disc (HD-DVD), a Blu-ray disc, a near field optical storage disc, a holographic storage medium, or another like volumetric optical storage medium, such as, for example, two-photon or multi-photon absorption storage format.

In accordance with exemplary aspects of the present technique, the diagnostic system 10 may also include detection module 28, where the detection module 28 may be configured to aid in proactive detection and predictive detection of faults in the system 10. In other words, the detection module 28 may be configured to aid in enhancing management of the fault detection workflow. Furthermore, according to exemplary aspects of the present technique, the detection module 28 may be configured to determine a working environment and/or a rule application attribute associated with the system 10.

As used herein, the term working environment is employed to refer to a setting that a system configured to generate one or more log files is operating in. In certain embodiments, the working environment may include a knowledge creation environment, a knowledge validation environment, a production environment, or a combination thereof. Additionally, the term rule application attribute is representative of a setting for the application of rules. The rule application attribute may include a data-based attribute, a frequency-based attribute, an input data variations-based attribute, or a combination thereof, in one embodiment.

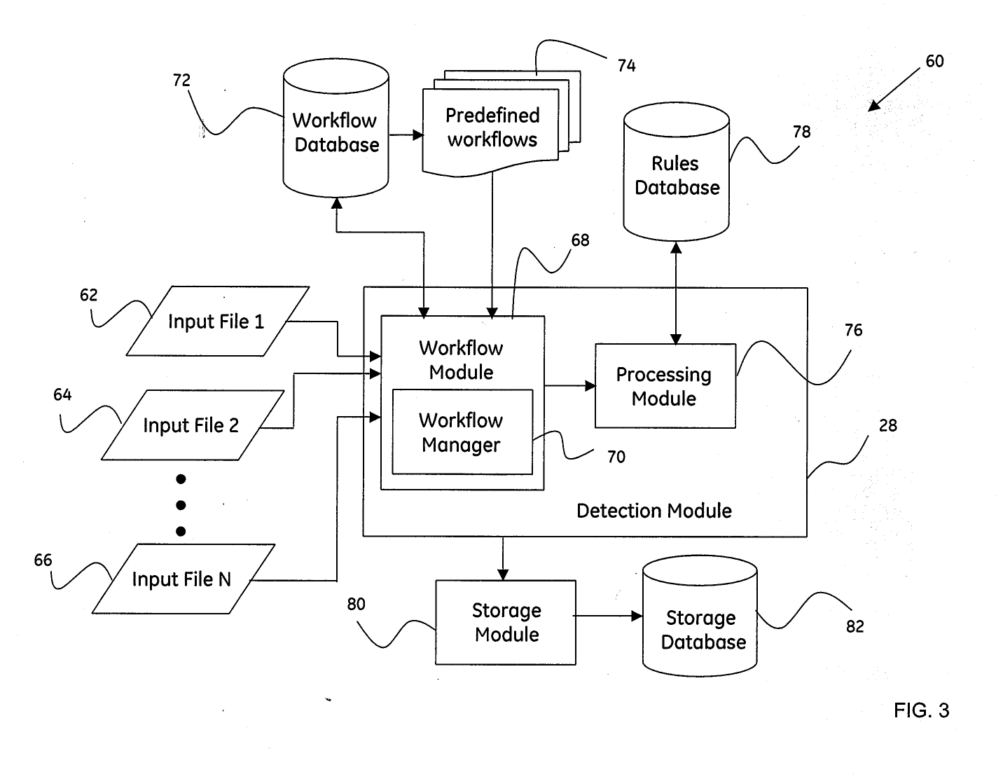

Furthermore, the detection module 28 may also be configured to optimize a sequence of operations to be performed based on the determined working environment and/or rule application attribute. Also, the detection module 28 may be configured to monitor a status of a system, such as the imaging system 18, operating in the determined working environment. In a similar fashion, the detection module 28 may also be configured to monitor a status of a system operating in a setting represented by the rule application attribute. The detection module 28 may then be configured to facilitate generation of a message indicative of the status of the imaging system 18. The generated message may then be communicated to a field service station 30, for example. In addition, the field service station 30 may then be configured to aid in the scheduling of a service visit by a field service technician, for instance. The working of the detection module 28 will be explained in greater detail with reference to FIGS. 3-10.

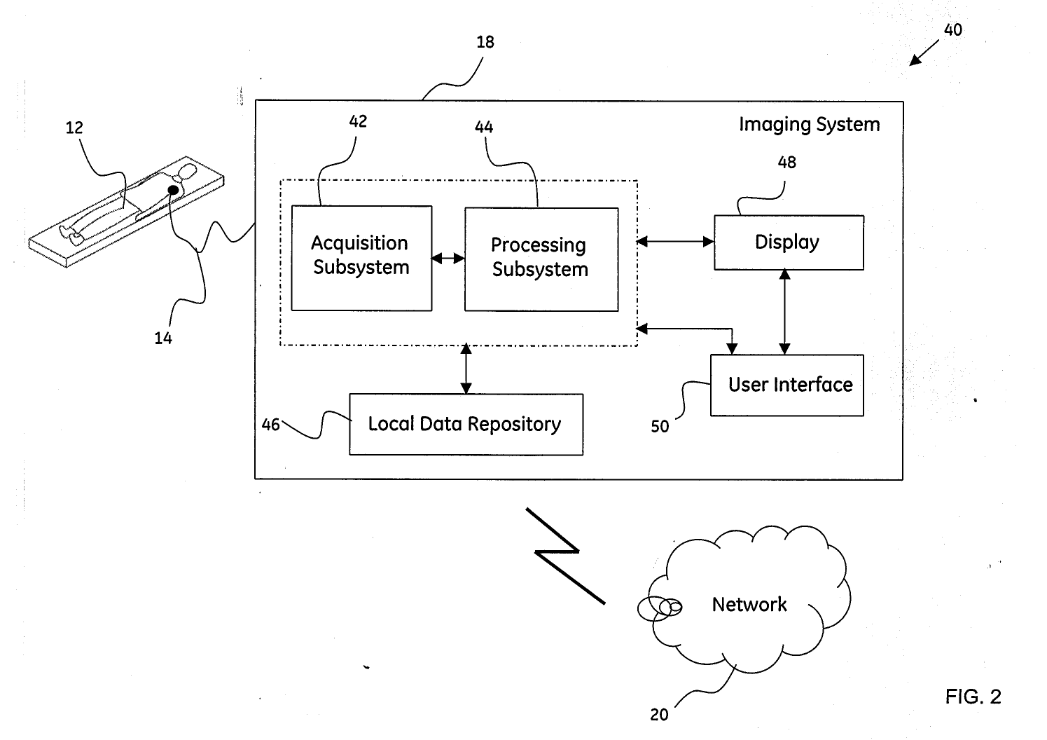

Turning now to FIG. 2, a block diagram 40 of the imaging system 18 (see FIG. 1) is illustrated. The imaging system 40 may be configured to acquire image data from the patient 12 (see FIG. 1) via an image acquisition device 14 (see FIG. 1), as previously noted with reference to FIG. 1. In a presently contemplated configuration, the medical imaging system 40 may include an acquisition subsystem 42 and a processing subsystem 44. Further, the acquisition subsystem 42 of the medical imaging system 40 may be configured to acquire image data representative of one or more anatomical regions of interest in the patient 12 via the image acquisition device 14. The image data acquired from the patient 12 may then be processed by the processing subsystem 44.

Additionally, the image data acquired and/or processed by the medical imaging system 40 may be employed to aid the clinician in identifying disease states, assessing need for treatment, determining suitable treatment options, and/or monitoring the effect of treatment on the disease states. In certain embodiments, the processing subsystem 44 may be further coupled to a local storage system, such as a local data repository 46, where the local data repository 46 is configured to receive image data. Furthermore, as previously noted, the medical imaging system 18 may also be configured to generate one or more log files, where the data in the log files is representative of an event, an error, machine critical parameters, sensor outputs, or a combination thereof. In one embodiment, the processing subsystem 44 may be configured to generate the one or more log files.

Furthermore, as illustrated in FIG. 2, the medical imaging system 40 may include a display 48 and a user interface 50. However, in certain embodiments, such as in a touch screen, the display 48 and the user interface 50 may overlap. Also, in some embodiments, the display 48 and the user interface 50 may include a common area. In accordance with aspects of the present technique, the display 48 of the medical imaging system 40 may be configured to display an image generated by the medical imaging system 40 based on the image data acquired via the image acquisition device 14. Additionally, in accordance with further aspects of the present technique, information associated with the detected faults may be visualized on the display 48, and will be described in greater detail with reference to FIGS. 3-10.

Moreover, the user interface 50 of the medical imaging system 40 may include a human interface device (not shown) configured to facilitate the clinician in organizing and/or managing image data displayed on the display 48. The human interface device may include a mouse-type device, a trackball, a joystick, a stylus, or a touch screen. However, as will be appreciated, other human interface devices, such as, but not limited to, a touch screen, may also be employed. Furthermore, in accordance with aspects of the present technique, the user interface 50 may be configured to aid the clinician in manipulating and/or organizing the information displayed on the display 48, and will be described in greater detail with reference to FIGS. 3-10.

Referring now to FIG. 3, a block diagram 60 of one embodiment of a detection system including the detection module 28 of FIG. 1 is depicted. In the example depicted in FIG. 3, reference numerals 62, 64 and 66 are representative of a plurality of log files obtained from one or more data sources, such as imaging systems. In certain embodiments, the log files 62, 64 and 66 respectively correspond to log files obtained from different imaging modalities. Alternatively, if a single imaging modality is employed to acquire image data, then the log files 62, 64 and 66 may be representative of log files generated by the single imaging modality but stored in different formats. Although, the exemplary embodiments illustrated hereinafter are described in the context of a log file generated by a medical imaging system, it will be appreciated that use of the diagnostic system 10 (see FIG. 1) in analyzing machine readable data generated by different data sources are also contemplated in conjunction with the present technique.

As previously noted with reference to FIG. 1, the detection module 28 (see FIG. 1) of the diagnostic system 10 (see FIG. 1) is configured to aid in the detection of faults associated with the system. In one embodiment, the detection module 28 may be configured to detect faults by analyzing the data in the log file, for example. Accordingly, the log files 62, 64, 66 may be processed by the detection module 28. In a presently contemplated configuration, the detection module 28 may include a workflow module 68 and a processing module 76. Additionally, in certain embodiments, the workflow module 68 may also include a workflow manager 70. The working of the workflow module 68 and the processing module 76 will be described in greater detail hereinafter.

Moreover, as will be appreciated, it is desirable to reduce system downtime observed by a customer. In other words, it may be desirable to reduce the system downtime from an “unplanned” downtime to a “planned” downtime. Accordingly, an enhanced fault detection framework is presented, where the fault detection framework may be configured to optimize the workflow of the fault detection process. More particularly, in accordance with exemplary aspects of the present technique, the fault detection framework may be configured to be a generic, configurable, scalable and distributable framework, thereby resulting in an optimized workflow of fault detection. It may be noted that the terms fault detection workflow and transactional workflow may be used interchangeably.

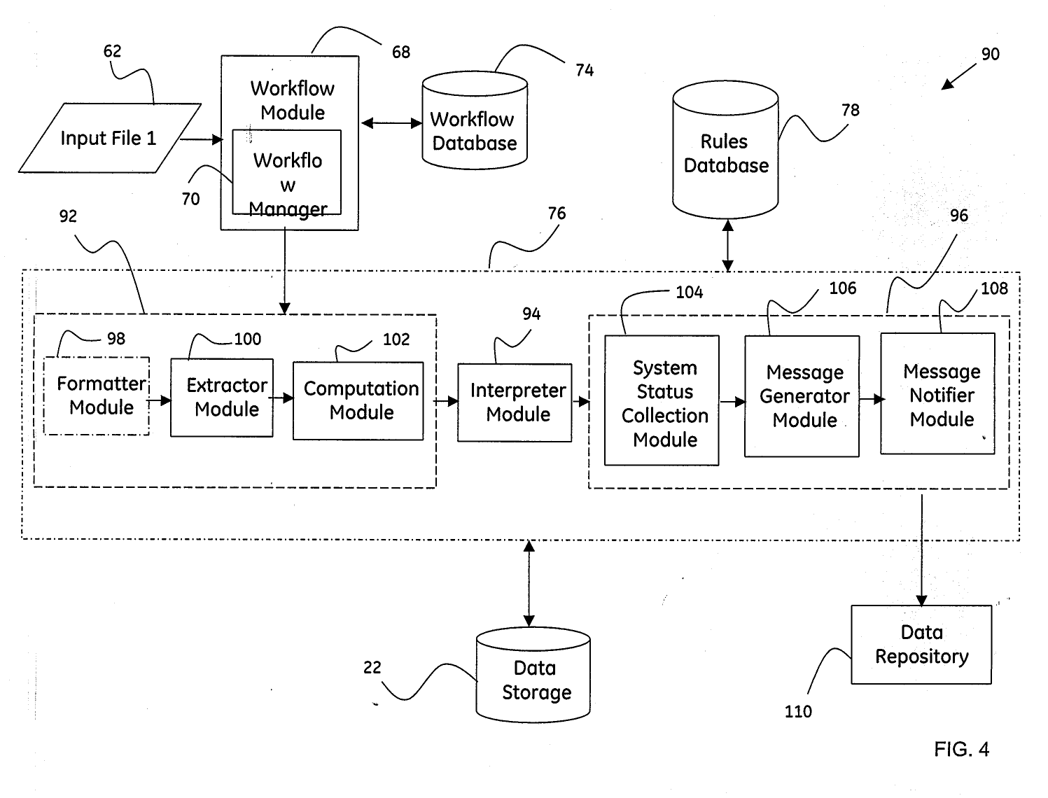

The detection module 28 may include a workflow module 68, as previously described. Furthermore, the workflow module 68 may be configured to facilitate optimization of the fault detection workflow. More particularly, the workflow module 68 may be configured to dynamically optimize the operations to be performed based on a working environment and/or a rule application attribute associated with a system, such as the medical imaging system 18 (see FIG. 1). The operations may be representative of steps that may be performed during a fault detection process and will be described in greater detail with reference to FIGS. 4-10. Further, the workflow module 68 may include a workflow manager 70, where the workflow manager 70 may be configured to aid in facilitating the optimization of the sequence of operations to be performed based on the working environment and/or the rule application attribute associated the imaging system 18.

Accordingly, in one embodiment, predefined transactional workflows 74 associated with a variety of systems may be stored in a workflow database 72. In other words, a predefined transactional workflow 74 associated with a corresponding system may be stored in the workflow database 72. Furthermore, the predefined workflow 74 may be representative of an optimized set of sequence of operations to be performed for a particular system operating in a given working environment. For example, a transactional workflow 74 or sequence of operations corresponding to a medical imaging system 18 may be stored in the workflow database 72. Similarly, predefined workflows associated with the rule application attribute may also be stored in the workflow database 74.

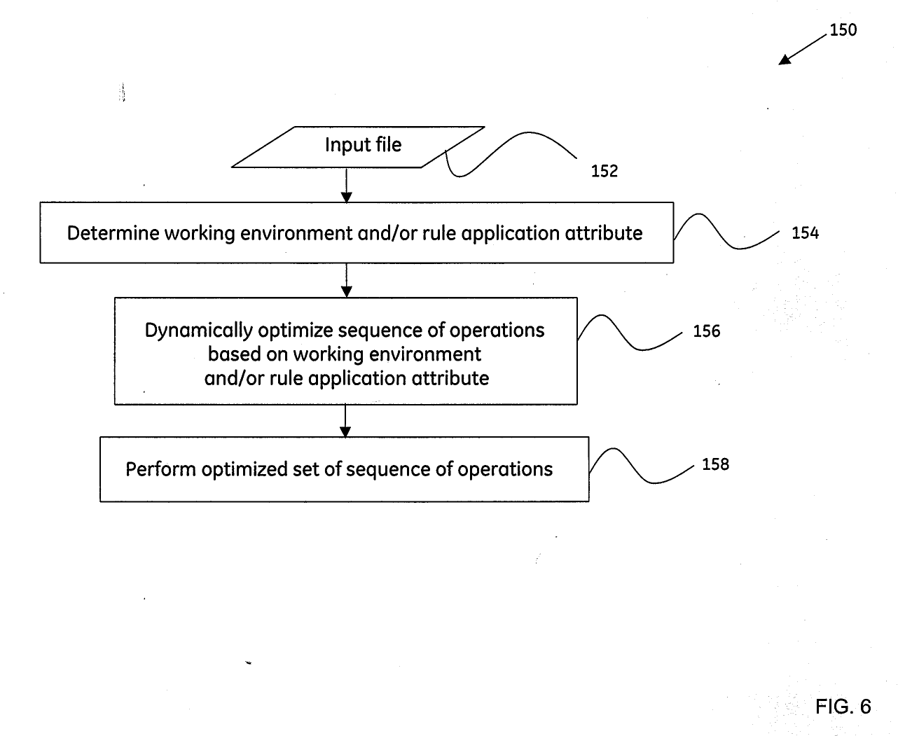

In one embodiment, on receiving an input log file, such as input file 62, the workflow manager 70 may be configured to determine a working environment associated with the system that generated the input log file 62. Further, as previously noted, the working environment may include a knowledge creation environment, a knowledge validation environment, a production environment, or a combination thereof, and will be described in greater detail with reference to FIGS. 6-10. The workflow manager 70 may then be configured to obtain a transactional workflow 74 corresponding to the determined working environment from the workflow database 72.

In accordance with further aspects of the present technique, the workflow manager 70 may also be configured to obtain information regarding the rule application attribute associated with the system. The rule application attribute may include a data-processing based environment, a frequency-based environment, a schedule-based environment, a validation-based environment, data input-based environment, or a combination thereof, and will be described in greater detail with reference to FIGS. 6-10.

The log data in the input file 62 may then be processed by the processing module 76 based on the predefined workflow 74 obtained from the workflow database 72. Additionally, the processing module 76 may also be configured to obtain one or more predefined rules from a rules database 78, where the predefined rules may be configured to aid in the processing of the log data. It may be noted that processed data generated consequent to processing by the processing module 76 may be communicated to a storage module 80 for temporary storage. The storage module 80 may include memory, in one embodiment. The processed data may also be communicated to a third storage 82 for permanent storage. In one embodiment, the third storage 82 may include a storage database as depicted in FIG. 3. The working of the processing module 76 may be better understood with reference to FIG. 4.

Turning now to FIG. 4, a block diagram 90 representative of a portion of the detection system 60 of FIG. 3 is illustrated. In a presently contemplated configuration, the processing module 76 is shown as including a pre-processing module 92, an interpreter module 94 and a post-processing module 96. In one embodiment, the pre-processing module 92 may be configured to pre-process the log data in the input file 62. In addition, the pre-processing module 92 may be configured to pre-process the log data based on one or more predefined rules, where the predefined rules are stored in a rules database 78, as previously noted.

As depicted in FIG. 4, in a presently contemplated configuration, the pre-processing module 92 may include a formatter module 98, an extractor module 100, and a computation module 102. In accordance with aspects of the present technique, the formatter module 98 may be configured to format the one or more input files 62, 64, 66. More particularly, the formatter module 98 may be configured to convert the data from a native format to a common format. The term native format is representative of a format that a system typically employs to log data. Also, the term common format is indicative of a standard format that aids in simplifying the process of identifying and extracting parametric data points. For example, the medical imaging system 18 may log the data into the input file 62 in a native format, where the native format may include a text format. The formatter module 98 may be configured to convert the native text format of the data in the input file 62 to a common format. Further, in one embodiment, the machine data in the input file 62 may be categorized into three types of common data format, namely, the parametric log format, the error event log format, and the system tracker log format. Accordingly, converting the format of the data in the input files to a common format simplifies the process of identifying and extracting information of interest from the log data downstream.

Additionally, in accordance with further aspects of the present technique, the extractor module 100 may be configured to extract information of interest from the input log file, such as log file 62, for example. More particularly, in accordance with exemplary aspects of the present technique, the extractor module 100 may be configured to extract information of interest from the log file 62 based upon one or more predefined rules. As used herein, the term “rules” may be used to refer to a predefined constraint that typically encompass any and all actions that should be taken within the scope of a problem. These rules may be collectively referred to a rule base, where the rule base may contain all of the knowledge associated with the rule-based system.

Also, in accordance with aspects of the present technique, the predefined rules may be representative of status of a system, such as the medical imaging system 18 (see FIG. 1). For example, the predefined rules may be employed to aid in detecting system status or health of the system 18. More particularly, a predefined set of parameters may be associated with a given imaging modality. The imaging modality may include an imaging system, such as, but not limited to, an ultrasound system, an X-ray system, a MR imaging system, a CT imaging system, or a combination thereof. Accordingly, for a given imaging modality, the predefined rules may include rules based on various combinations of the associated parameters and/or indicators. Furthermore, a set of rules may be defined for each of the imaging modalities, where the rules may include parameter-based rules and/or indicator-based rules. Additionally, the predefined rules may include information of interest to be extracted from the log file. The information of interest may be representative of one or more error codes generated by the imaging system 18, in one embodiment.

As noted hereinabove, the extractor module 100 may be configured to search data in the log file 62 for matching information of interest and extract the information of interest specified in the predefined rules from the log file 62. In one embodiment, the information of interest to be extracted may include one or more parameters, one or more indicators, one or more error codes, or a combination thereof as listed in the predefined rules. The information of interest may then be employed to detect status and/or health of the medical imaging system, for instance. The information of interest may also be used for predictive detection and/or proactive detection.

Furthermore, the predefined rules may be stored in a second storage 78, in one embodiment. In a presently contemplated configuration, the second storage 78 may include a rules database that is configured to store the predefined rules. The extractor module 100 may be configured to query the rules database 78 to obtain the one or more predefined rules. More particularly, the extractor module 100 may be configured to query the rules database 78 to obtain data associated with the information of interest to be extracted. The extractor module 100 may be further configured to parse through the data in the log file 62 to extract the information of interest based upon the predefined rules stored in the rules database 78. Techniques, such as, but not limited to, standard file reading techniques, regular expression techniques, or transformation techniques may be employed by the extractor module 100 to parse through the log file 62 to extract the information of interest.

As will be appreciated, the log file 62 may include a substantial amount of data. For example, a log file may typically have a size in a range from about 100 kilobytes to about 100 megabytes. The extractor module 100 may thus be configured to parse through typically large amount of data in the log file and extract only the information of interest indicated in the rules database 78. The extractor module 100 may search through the log file 62 for matches based on the information to be extracted. It may be noted that the extractor module 100 may be configured to search for an exact match of the information of interest to be extracted. However, a near match of the information of interest may also be extracted from the log file 62. Furthermore, the extractor module 100 may also be configured to apply proximity matching techniques to extract the information of interest from the log file 62.

Subsequent to processing by the extractor module 100, the information of interest may be extracted from the log data based on the predefined rules. According to aspects of the present technique, the extracted information of interest, namely the parsed data, may be saved in data storage system 22 (see FIG. 1). Alternatively, the extracted information of interest may be saved in an output file configured to only include the information of interest that has been extracted from the log file 62. As noted hereinabove, in the present example, the information of interest to be extracted may include the parameters, indicators, and/or error codes listed in the predefined rules. Consequently, in the present example, the extracted data may include information associated with the parameters, indicators, and/or error codes.

Furthermore, in accordance with exemplary aspects of the present technique, the processing module 76 may be configured to process the extracted information of interest in light of the predefined rules stored in the rules database 78. Although the working of the processing module 76 is described in terms of the extracted data, it may be noted that the processing module 76 may also be configured to process the log data stored in data storage system 22, for example.

In addition, in one embodiment, the number of facts to test the conditions of each rule may be substantially reduced by pre-computing the facts according to the predefined rules, thereby dramatically improving the performance of the interpreter module 94. Accordingly, the computation module 102 may be configured to aid in enhancing the performance of the fault detection system 60 by performing any pre-calculations of the extracted data according to the predefined rules.

The data processed by the pre-processing module 92 may then be communicated to the interpreter module 94. In one embodiment, the interpreter module 94 may include an inference engine. As will be appreciated, the inference engine 94 may be defined as a computer program that is configured to derive answers from a knowledge base. The inference engine 94 may be referred to as the “brain” that expert systems use to reason about the information in the knowledge base, for the ultimate purpose of formulating new conclusions.

In one embodiment, the inference engine 94 may include a working memory (not shown) and a pattern matcher (not shown). The working memory may be defined as a workspace including a small set of data items representing the current state of knowledge of a system, such as the medical imaging system 18 (see FIG. 1), at any stage in the performance of a task, and which is transformed into a new set in production systems on the firing of a new production rule. The working memory may be configured to serve as a global database of symbols representing facts or assertions about the problem. As will be appreciated, the inference engine 94 may examine all the rule conditions (IF) and determine a subset, the conflict set, of the rules whose conditions are satisfied based on a working memory, where the working memory may include any data, assertions or initially known information. Subsequently, one of the rules chosen from the conflict set based on a conflict resolution strategy may be triggered. In many applications, where large volume of data is concerned and/or when performance time considerations are critical, the computation of a conflict set is a non-trivial problem.

As noted hereinabove, the inference engine 94 may be configured to find all of the rules that are satisfied by the current contents of the working memory by testing the conditions against the working memory. Furthermore, while handling a large volume of data in the log file 62, especially when the rules include complex calculations, the computation of the conflict set results in a non-trivial problem. More particularly, complex rules entail testing and retesting conditions for each rule against all the supplied facts, thereby resulting in a time-consuming and cumbersome process. Accordingly, the number of facts to test the conditions of each rule may be substantially reduced by pre-computing the facts according to the predefined rules, thereby dramatically improving the performance of the inference engine 94. Subsequent to processing by the inference engine 94, interpreted data may be generated.

The interpreted data may then be processed by the post-processing module 96. In a presently contemplated configuration, the post-processing module 96 is shown as including a system status collection module 104, a message generator module 106, and a message notifier module 108. The system status collection module 104 may be configured to collect data indicative of a status of a system, such as the imaging system 18 (see FIG. 1), in one embodiment. The system status data may include one or more error codes representative of probable system failures, for example. Subsequently, the system status data may be formatted in the form of a message by the message generator module 106. The message so generated may be configured to include information representative of faults associated with the system under investigation, for example. Further, this message may be communicated by the message notifier module 108 to a field service station, such as field service station 30 (see FIG. 1), a field service technician, or both. The generated message and/or the system status data may be stored in a third storage, such as data repository 110, for example. Alternatively, the data storage system 22 (see FIG. 1) may also be utilized to store the generated message and/or the system status data.

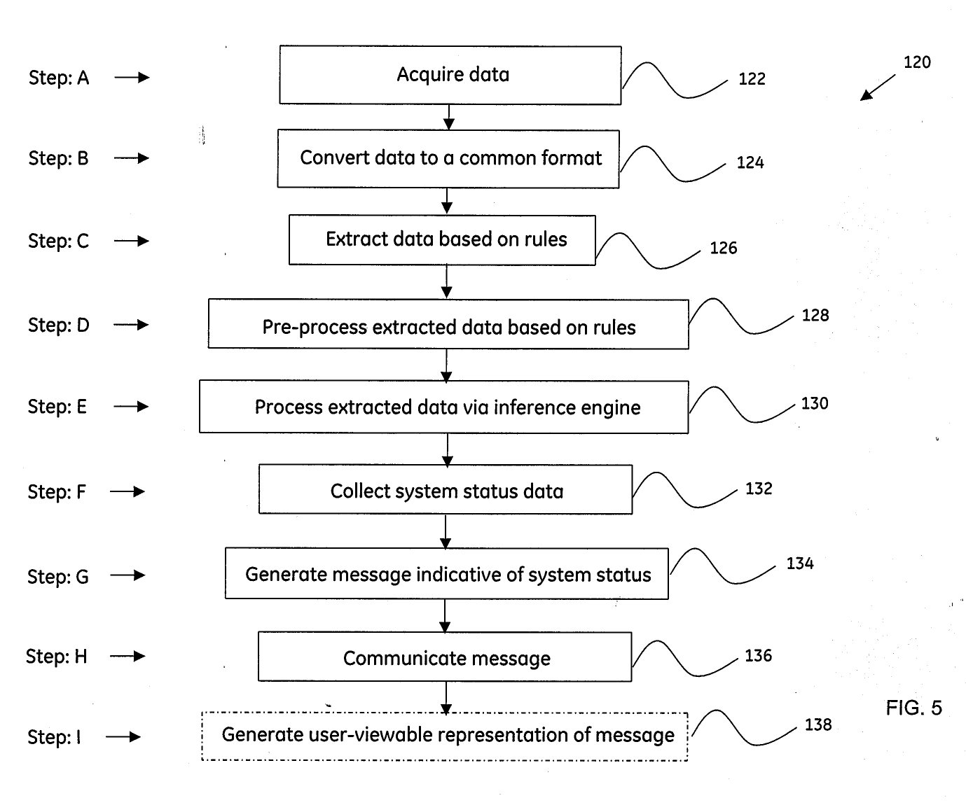

Referring now to FIG. 5, a flowchart 120 representative of an exemplary transactional workflow 120 for fault detection in systems is illustrated. Although the transactional workflow is described in reference to the workflow depicted in FIG. 5, it may be noted that other transactional workflows are also contemplated in conjunction with the present technique. The fault detection workflow 120 depicted in FIG. 5 may be configured to include a data acquisition step A 122, where log data may be acquired from a predetermined data source. For example, the log data may be acquired from the input file 62 (see FIG. 3), where the input log file 62 is stored in the data storage system (see FIG. 1). As previously noted, log data generated by a system, such as the medical imaging system 18 (see FIG. 1), may be transmitted to a predetermined location and stored at the predetermined location. In a presently contemplated configuration, the predetermined location may include the data storage system 22 (see FIG. 1).

Subsequently, at step B 124, data in the log file may be converted to conform to a common format. More particularly, the data in the log file may be converted from a native format to a standard common format. Converting the log data to a common standard format advantageously aids in identifying and extracting information of interest from the log file. Additionally, step B 124 may also involve validation checks to remove any inconsistencies and/or variations in the input log data. Furthermore, at step B 124, different data formats associated with a wide variety of systems may be identified, and corresponding transformations may be applied to convert the data into one or more structured formats.

Furthermore, the fault detection workflow may also involve extraction of information of interest from the input log file, as indicated by step C 126. More particularly, information of interest may be extracted from the input log file 62 based on one or more predefined rules, where the rules may be obtained from a rules database 78 (see FIG. 3), for example. Information of interest to be extracted from the input log file may include a parameter, an error code, or a combination thereof. Accordingly, step C 126 may entail parsing through the data in the input log file 62 to extract the information of interest based upon the predefined rules. Techniques, such as, but not limited to, standard file reading techniques, regular expression techniques, or transformation techniques may be employed to parse through the log file to extract the information of interest. By extracting the information of interest based on the predefined rules from the input log file, the size of the data to be processed downstream is substantially reduced as non-pertinent information is filtered out from the log file based on the predefined rules. In other words, only relevant information of interest is extracted from the log file for further processing downstream, thereby enhancing the efficiency and speed of a rule-based system.

Following step C 126, the extracted data may be pre-processed based on the predefined rules, at step D 128. Step D 128 may entail any pre-computation or derivation from the extracted data, where the pre-computed and/or derived data may then be further processed downstream. Subsequent to step D 128, pre-processed data may be generated. The pre-processed data may then be processed via an inference engine, such as inference engine 94 (see FIG. 4) at step E 130. In other words, at step E 130, available knowledge may be utilized to execute decision making actions to generate inferences of faults and/or other actions.

With continuing reference to FIG. 5, data indicative of system status may be collected at step F 132. The system status data may include information regarding a state of the system at the time of failure. Further, the system status data may advantageously be employed to facilitate speedy diagnosis and/or servicing of the system. Subsequently, the system status data collected at step F 132 may be formatted in the form of a message at step G 134. The message so generated may include information regarding inferences of faults and/or actions generated at step E 130. In addition, the message may also include system status data collected at step F 132. Further, at step H 136, the message generated at step G 134 may be communicated to a field service station, such as the field service station 30 (see FIG. 1), a field service technician, or both. Additionally, as indicated by step I 138, a user-viewable representation of the information gathered may be generated for display on a display, such as display 48 (see FIG. 2). More particularly, the user-viewable representation may be representative of dashboards for a customer, where the dashboards may provide information regarding a number of faults detected for each system, failures, potential failure conditions, alarm status, planned outages, or fault fixes performed. Furthermore, the field service station 30 may dispatch a field service technician to a location of the system for further investigation.

By implementing the fault detection workflow as described hereinabove, a generic framework for transactional workflow for fault detection may be obtained. This generic framework may be organized to be configurable, thereby providing a flexible and scalable solution to perform the identified operations towards efficient fault detection and/or diagnosis. Furthermore, this framework may be configured to be flexible enough to accommodate a given scheme of implementation for the identified operations. More particularly, the transactional workflow framework may be configured to identify mandatory operations that need to be performed and also operations that may be optional. Additionally, the framework may be configured to specify an optimal sequence of operating the identified mandatory and/or optional operations based on a working environment in which the operations are carried out. Consequently, in accordance with exemplary aspects of the present technique, the fault detection workflow framework may be configured to dynamically change a sequence of operations based on the working environment and/or the rule application attribute, thereby resulting in an optimized set of operations for a given system. Furthermore, this framework may also be configured to accommodate audit trail of each of the operations, which in turn aids in tracking and providing dashboard reports of the operations.

In accordance with exemplary aspects of the present technique, the exemplary fault detection workflow framework presented in FIG. 5 may be employed by the detection module 28 (see FIG. 1) to aid in the detection and/or diagnosis of faults in a system, such as the medical imaging system 18 (see FIG. 1). The working of the detection module 28 may be better understood with reference to the exemplary logic depicted in FIGS. 6-10. Turning now to FIG. 6, a flow chart of exemplary logic 150 for fault detection is illustrated. In accordance with exemplary aspects of the present technique, a method for fault detection workflow management is presented.

The method starts at step 154 where data in an input file 152 is used to determine a working environment associated with a system that generated the input file 152. Additionally, at step 154, information associated with a rule application attribute corresponding to a system may also be obtained. As previously noted, the working environment may include a knowledge creation environment, a knowledge validation environment, a production environment, or a combination thereof, while the rule application attribute may include a data-based attribute, a frequency-based attribute, an input data variations-based attribute, or a combination thereof. Although the present embodiment is described in terms of the data source including a previously stored file, such as a log file, it will be appreciated that step 154 may also be configured to process a real-time data stream. Additionally, the data in the log file may include machine-readable date, as previously noted.

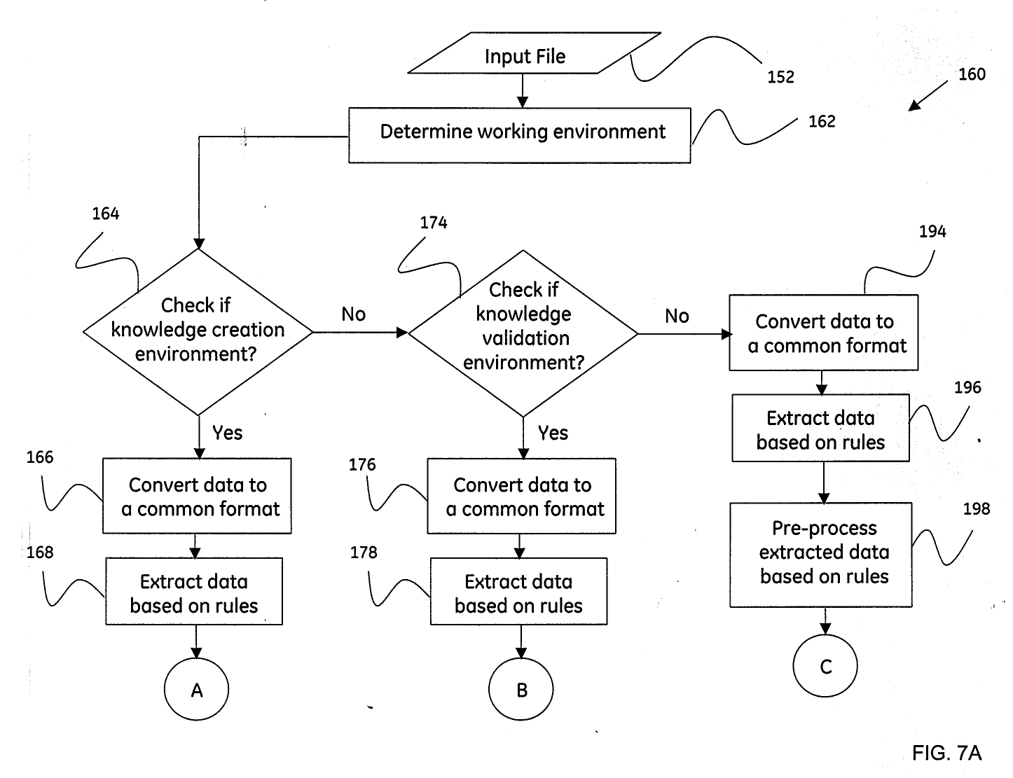

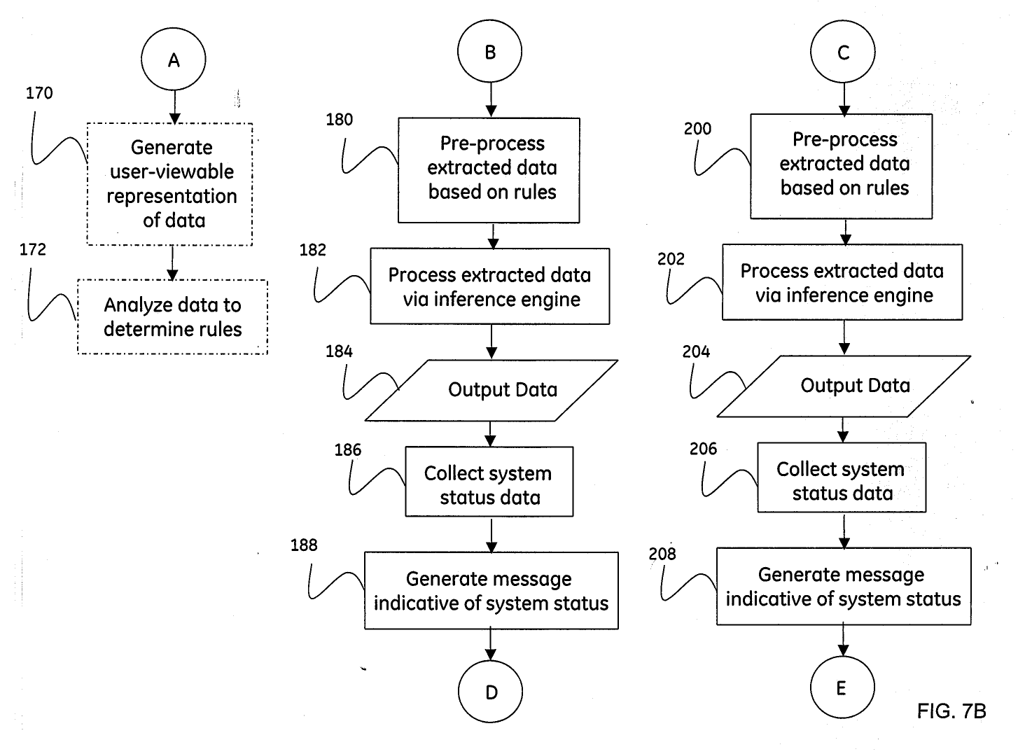

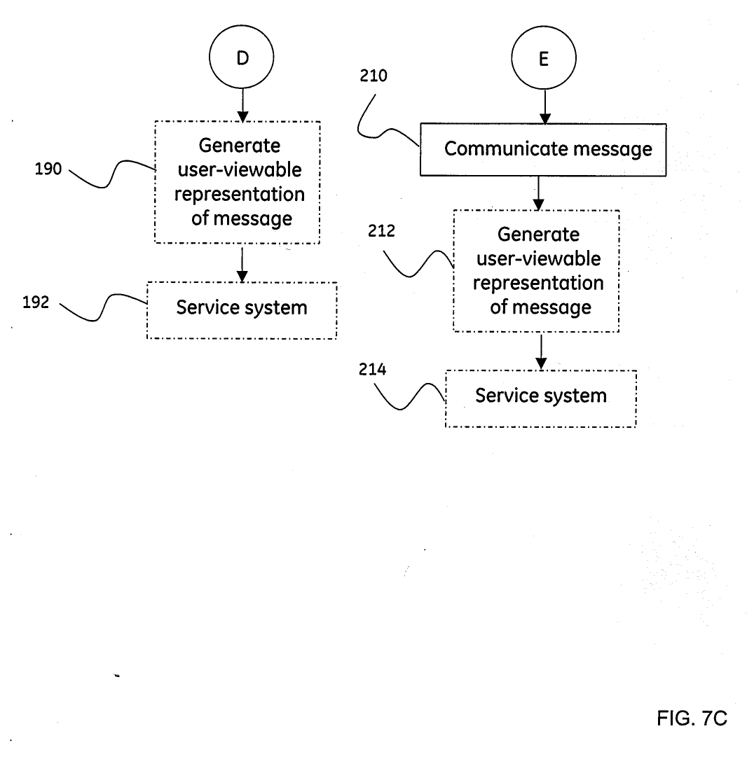

Subsequently, at step 156, a sequence of operations to be performed may be identified based on the working environment and/or rule application attribute determined at step 154. More particularly, the sequence of operations in the fault detection workflow may be dynamically optimized based on the determined working environment and/or rule application attribute. As previously noted, predefined workflows may be stored in the workflow database 72. Once the working environment associated with the input file 152 is determined at step 154, the workflow manager 70 (see FIG. 3) may be configured to query the workflow database 72 (see FIG. 3). A predefined workflow that is associated with the system that generated the input log file 152 and the determined working environment may then be retrieved from the workflow database 72 by the workflow manager 70, at step 156. Subsequently, at step 158, the sequence of operations defined in the predefined workflow may be performed. The exemplary method of fault detection workflow management depicted in steps 154-158 may be better understood with reference to FIGS. 7A-7C.

As described hereinabove, the working environment may include a knowledge creation environment, a knowledge validation environment, a production environment, or a combination thereof. The knowledge creation environment may be indicative of a setting where rules associated with a given system are created. More particularly, in the knowledge creation environment, rules for determining failure events associated with a given system may be created. Further, the knowledge validation environment may be representative of a setting where the created rules may be verified for correctness. More particularly, the rules created in the knowledge creation environment, for example, may be run on corresponding systems in a test environment. The validity of the created rules may be verified by monitoring the application of these rules on a sample set of systems and determining a number of valid detections and a number of false detections of failure events. Additionally, the production environment may be indicative of a service environment, where the validated rules are applied on all systems that are under a service contract, for example. The failure events in the production environment may be proactively detected and field service technicians may be notified to take necessary corrective actions in order to reduce system downtime.

With continuing reference to FIG. 6, if at step 154 it is verified that the working environment is being determined, then the workflow manager 70 may be configured to obtain a predefined fault detection workflow corresponding to the determined working environment from the workflow database 72. FIGS. 7A-7C are flow charts of exemplary logic 160 for fault detection based on the working environment associated with the system that generated the input file 152. The method starts at step 162, where a check is carried out to determine the working environment of the input file 152.

Further, if at step 164 it is determined that the environment is a knowledge creation environment, then the workflow manager 70 (see FIG. 3) may be configured to query the workflow database 72 to obtain a corresponding predefined workflow. In the illustrated embodiment, the fault detection workflow framework may be configured to include steps 166-172. In other words, reference numerals 166-172 are representative of operations in an optimized transactional workflow for a knowledge creation environment. Furthermore, steps 166-168 may be substantially similar to the transactional workflow depicted in steps B-C 124-126. Subsequently, at step 170 a user-viewable representation of the extracted data may be generated. This user-viewable representation of the extracted data may then be employed to create rules, as depicted in step 172.

However, at decision block 164, if it is determined that the working environment does not include a knowledge creation environment, then a subsequent check may be carried out at step 174. At step 174, if it is verified that the working environment includes a knowledge validation environment, then steps 176-192 may be performed. It may be noted that steps 176-188 may be representative of steps B-G 124-134 of FIG. 5. Subsequently, step 190 may be performed, where a user-viewable representation of a message generated at step 188 may be generated. Step 190 may be representative of step 1138 of FIG. 5. Furthermore, at decision block 174, if it is verified that the environment includes a production environment, then steps 194-212 may be performed. It may be noted that steps 194-212 may be indicative of steps B-H 124-136 of FIG. 5. Also, for the production environment, step 214 may be carried out, where step 214 may entail servicing of the system.

By implementing the workflow as depicted in FIGS. 7A-7B, a fault detection workflow that is dynamically optimized based on a working environment is obtained. For example, in the knowledge creation environment, the sequence of operations in the fault detection workflow may include fewer operations configured to aid in the creation of rules based on the input log data. In addition, in the knowledge validation environment, a message indicative of the system status may be generated at step 188, but the message may not be communicated to the field service station. However, in the production environment, a message may be generated at step 208 and the generated message may be communicated to a field service station as indicated by step 210.

Furthermore, as described hereinabove, a sequence of operations in the fault detection workflow may be dynamically optimized based on a rule application attribute. As previously noted, the rule application attribute may include a data-based attribute, a frequency-based attribute, an input data variations-based attribute, or a combination thereof.

As used herein, the term data-based attribute may be employed to indicate that it is desirable to execute a fault detection workflow based on the input log data. More particularly, the data-based attribute may be utilized to indicate that a fault detection workflow is to be executed by the detection module 28 (see FIG. 3) every time the log data is received by the data storage system 22 (see FIG. 1), for example. Additionally, the term frequency-based attribute may be used to indicate a frequency of execution of a fault detection workflow. In one embodiment, the frequency-based attribute may be employed to execute a fault detection workflow at predetermined intervals. For example, the frequency-based attribute may be configured to execute a fault detection workflow every six hours to check if disk usage is greater than 80% and archive old data. In this example, “six hours” is representative of a frequency, “disk usage >80%” is the rule and “archive old data” is a service action or alert for service.

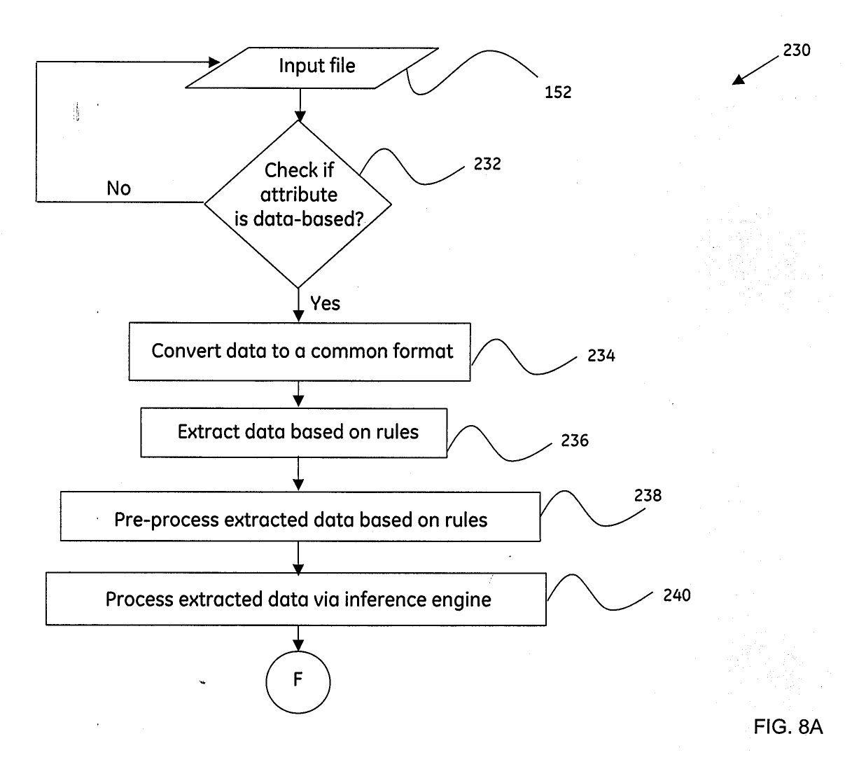

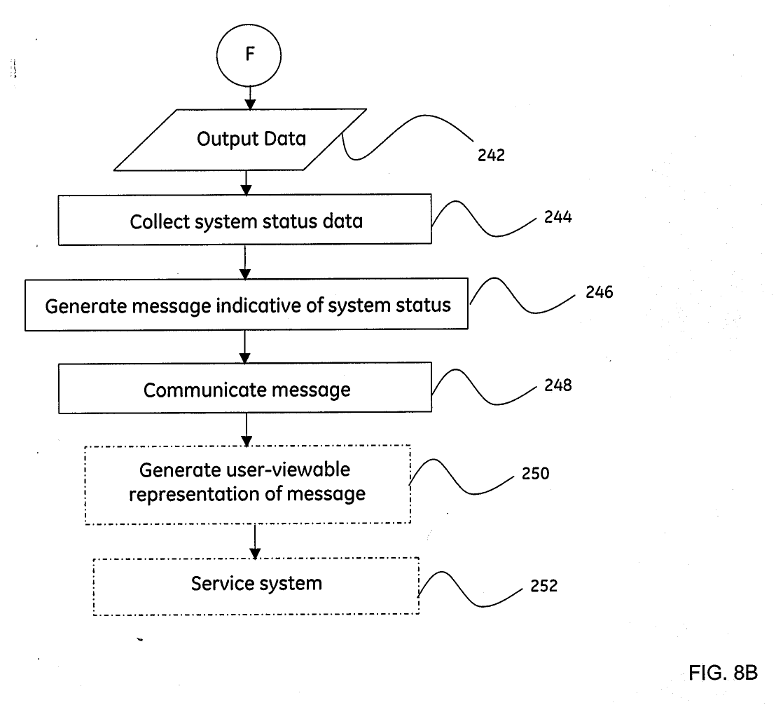

With continuing reference to FIG. 6, if at step 154 it is determined that the working environment is data-based, then the workflow manager 70 may be configured to obtain a predefined fault detection workflow from the workflow database 72. FIGS. 8A-8B are flow charts of exemplary logic 230 for fault detection based on a data-based attribute. The method starts at step 232, where a check is carried out to determine the type of rule application attribute associated with the input file 152. If it is determined that the rule application attribute includes a data-based attribute, then the fault detection workflow framework may be configured to include steps B-I 124-138 illustrated in FIG. 5. In other words, reference numerals 234-250 are representative of operations in an optimized transactional workflow for fault detection based on a data-based attribute. Furthermore, steps 234-250 may be substantially similar to the transactional workflow depicted in steps B-I 124-138. Subsequently, steps 234-250 may be performed to process the data in the input file 152. The system may then be serviced as indicated by step 252. By implementing the workflow as depicted in FIGS. 8A-8B, a fault detection workflow that is dynamically optimized based on a data-based attribute is obtained.

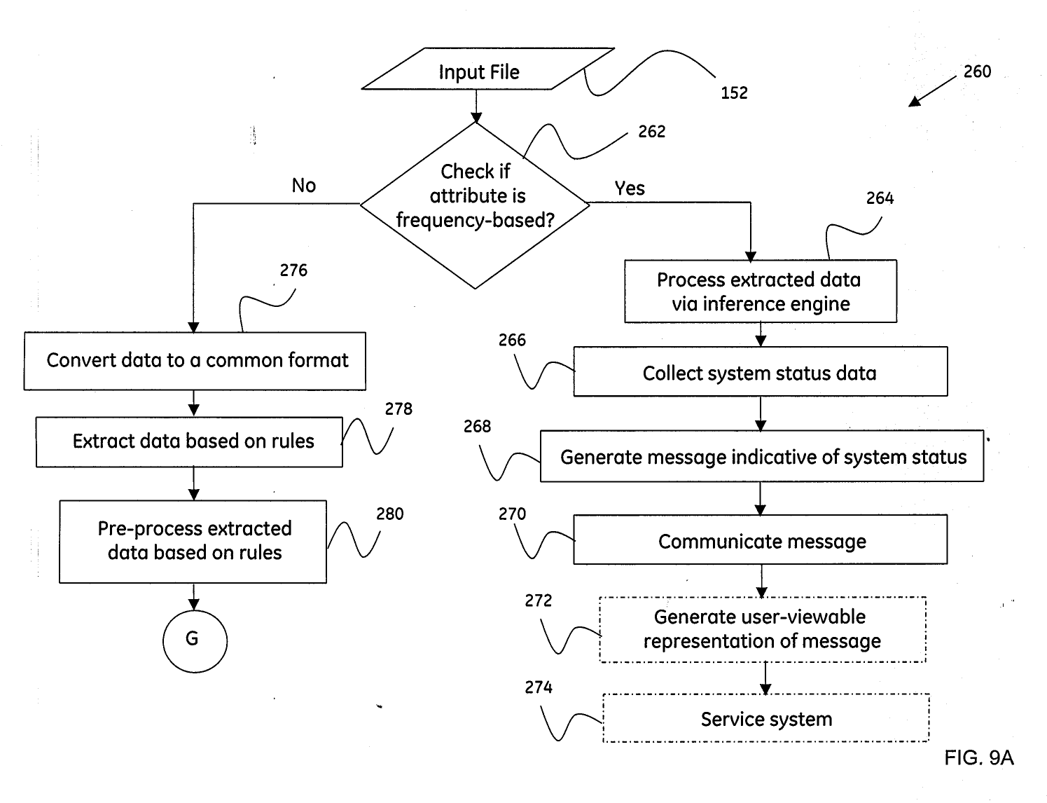

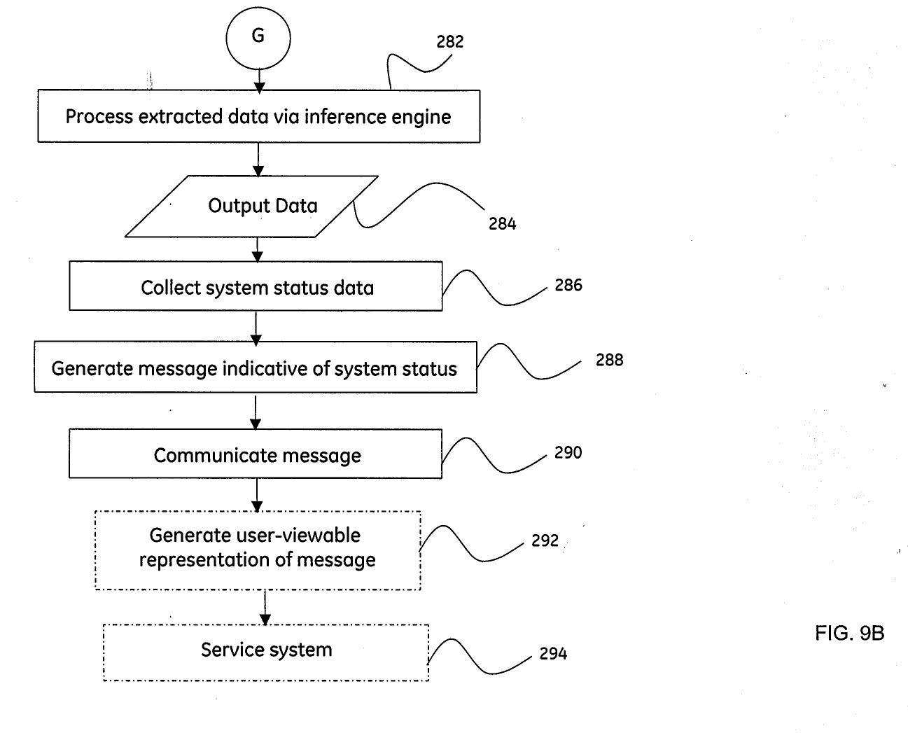

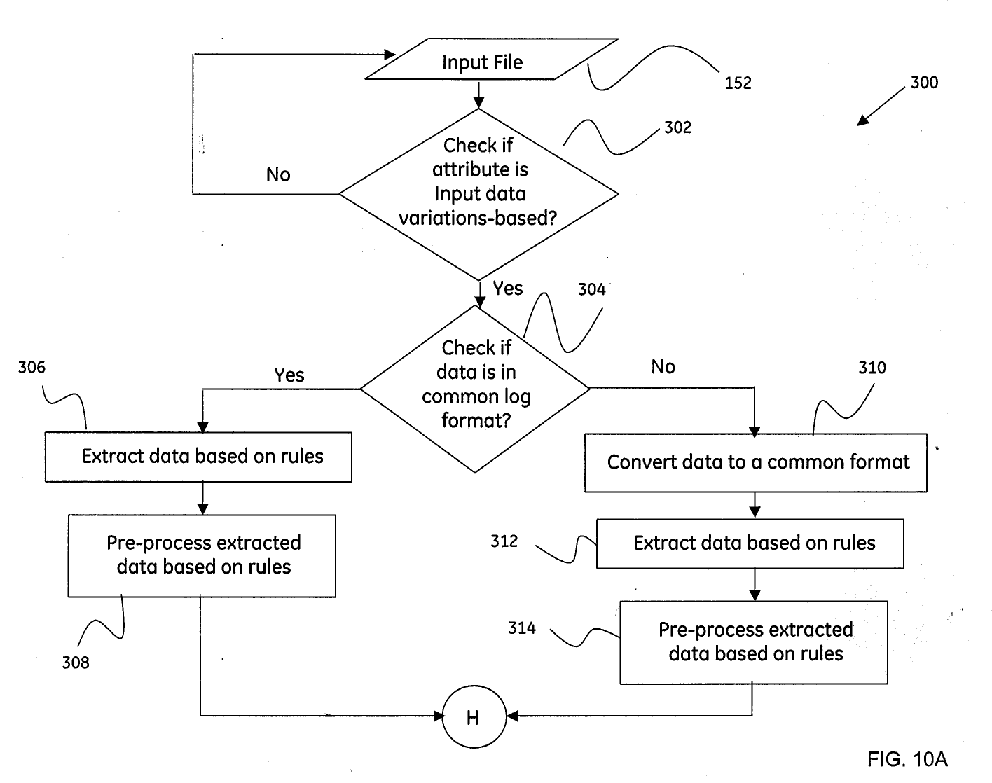

Referring again to FIG. 6, if at step 154 it is determined that the rule application attribute includes a frequency-based attribute, then the workflow manager 70 may be configured to facilitate the retrieval of a corresponding predefined workflow from the workflow database 72. Turning now to FIGS. 9A-9B, flow charts of exemplary logic 260 for fault detection based on a frequency-based attribute are depicted. It may be noted that the terms frequency-based attribute and schedule-based attribute may be used interchangeably. The method starts at step 262 where a check is carried out to determine if the rule application attribute associated with the input file 152 includes a frequency-based attribute. If it is determined that the rule application attribute of the input file 152 is frequency-based, then a corresponding predefined transactional workflow may be obtained from the workflow database 72. In one embodiment, steps 264-272 may be representative of an optimized sequence of operations associated with a frequency-based attribute. It may be noted that steps 264-272 may be representative of steps E-I 130-138 depicted in FIG. 5. However, at decision block 262, if it is determined that the rule application attribute is not frequency-based, then steps 276-292 may be performed, where steps 276-292 may be indicative of steps B-I 124-138 of FIG. 5. Steps 274 and 294 are representative of servicing of the system.

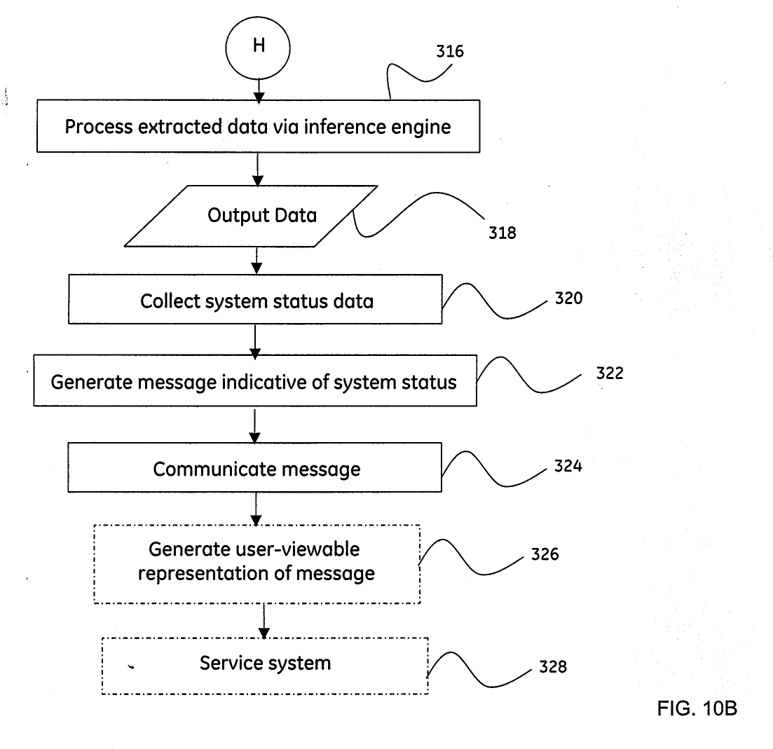

With returning reference to FIG. 6, if at step 154 it is determined that the rule application attribute includes an input data variations-based attribute, then exemplary logic depicted in FIGS. 10A-10B may be employed to facilitate fault detection. FIGS. 10A-10B are flow charts of exemplary logic 300 for fault detection when the rule application attribute is input data variations-based. The method starts at step 302 where a check is carried out to verify if the rule application attribute is input data variations-based. At step 302, if it is verified that the rule application attribute is input data variations-based, then another check may be carried out at step 304 to verify if the data in the input log file 152 is in a common log format. Following the check at step 304, if it is verified that the data in the log file 152 is in a common log format, then steps 306-308 may be performed. It may be noted that steps 306-308 may be representative of steps C-D 126-128 of FIG. 5. However, if at decision block 304 it is determined that the data in the log file 152 is not in the common log format, then steps 310-314 may be performed. It may be noted that steps 310-314 may be representative of steps B-D 124-128 of FIG. 5. Accordingly, if the log data is in the common format, then step configured to convert data to a common format may be skipped. Subsequently, steps 316-326 may be performed, where steps 316-326 may be representative of steps E-I 130-138 of FIG. 5. Also, step 328 may be representative of a servicing step.

By implementing the workflow as depicted in FIGS. 10A-10B, the fault detection workflow may be dynamically optimized based on the data in the input log file. In other words, if the log data is in conformance with the common format, then the formatting step (step B 124, see FIG. 5) may be skipped, thereby optimizing the fault detection workflow. Additionally, in certain other embodiments,

Referring to the workflows depicted in FIGS. 7-10, it may be noted that by implementing the fault detection workflow as described in FIGS. 7-10, it may be noted that the fault detection workflow framework presented in FIG. 5 is configurable to accommodate a desirable implementation of the identified operations based on an identified working environment. For example, as depicted in FIGS. 8A-8B associated with a data-based attribute, the identified operations of data acquisition, formatting, extracting, pre-processing, processing via the inference engine, collection of system status data, generation of a message, communication of the message, and outputting the results (steps A-I 122-138, see FIG. 5) may be applied for detecting system failure as and when the system completes the event logging.

On the other hand, as illustrated in FIGS. 9A-9B associated with a frequency-based attribute, the pre-processed data may be utilized to perform steps E-I 130-138 (see FIG. 5), where the pre-processed data may include log data that has been formatted, extracted, pre-processed (steps B-D 122-128, see FIG. 5) and stored in the data storage system 22 (see FIG. 1), for example. In other words, the stored, pre-processed data may be used to analyze and determine and/or detect the machine state, for example. Also, as depicted in FIGS. 10A-10B corresponding to an input data variations-based attribute, the formatting step may be skipped if the log data is in conformance with the common format.

Consequently, based on the working environment and/or the rule application attribute, an optimized set of operations may be applied to aid in fault detection, thereby advantageously enhancing the serviceability of systems. Additionally, the response time may be substantially improved as the fault detection workflow framework described hereinabove supports faster execution of the fault detection method by dynamically changing the operations to be performed and thereby optimizing the sequence of operations to be performed.

Furthermore, in accordance with exemplary aspects of the present technique, the fault detection workflow framework may be configured to be distributable and/or scalable. For example, in one embodiment, the data acquisition step (step A 122, see FIG. 5) and the formatting step (step B 124, see FIG. 5) may be performed by the medical imaging system 18 (see FIG. 1), while steps C-I 126-138 (see FIG. 5) may be performed by the detection module 28 (see FIG. 1). Therefore, the operations of step A-I 122-138 may be configured to be modular and hence may be configured to facilitate the distribution of the identified operations based on specific needs. More particularly, the identified operations may be distributed across local and remote monitoring servers based on the resource availability and other business parameters like cost, ease of upgrade, and/or security. In addition, the operations in the fault detection workflow framework depicted in FIG. 5 may be load balanced across multiple servers for monitoring at a local site and/or a remote site to achieve high performance and capacity, thereby allowing the framework to be scalable.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++ or Java. Such code, as will be appreciated by those of ordinary skill in the art, may be stored or adapted for storage on one or more tangible, machine readable media, such as on memory chips, local or remote hard disks, optical disks (that is, CDs or DVDs), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

The method for fault detection workflow management and the system for detection described hereinabove dramatically enhance the remote serviceability of the systems through automated detection. Additionally, the configurable nature of the fault detection workflow enables efficient fault detection. Furthermore, the framework supports faster execution of the operations based on the input machine data by dynamically optimizing the sequence of operations to be performed. Also, the framework facilitates continuous diagnostic improvement as the framework tracks the execution of all identified tasks and generates dashboard reports that enable identification of diagnostic improvements by addition or modification of tasks. Also, customer data security may be dramatically enhanced due to the modular nature of the framework since the fault detection framework may be configured to transmit only relevant information from the medical imaging systems. Also, the fault detection framework may be configured to provide flexibility to incorporate additional data securing tasks. In addition, the framework enables the customer to track the history and status the proactive services performed on the system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for fault detection workflow management, the method comprising:
determining a working environment, a rule application attribute, or both, wherein the working environment and the rule application attribute are associated with input data;
dynamically optimizing a sequence of operations based on the determined working environment, the determined rule application attribute, or both; and
processing the input data based on the optimized sequence of operations.

2. The method of claim 1, wherein the working environment comprises a knowledge creation environment, a knowledge validation environment, a production environment, or a combination thereof.

3. The method of claim 1, wherein the rule application attribute comprises a data-based attribute, a frequency-based attribute, an input data variations-based attribute, or a combination thereof.

4. The method of claim 1, wherein the input data comprises machine-readable data obtained from a data source, and wherein the data source comprises a data stream or archived data.

5. The method of claim 4, wherein the data source comprises an imaging system, and wherein the imaging system comprises one of a computed tomography imaging system, a positron emission tomography imaging system, a magnetic resonance imaging system, an X-ray imaging system, a nuclear medicine imaging system, an ultrasound imaging system, or combinations thereof.

6. The method of claim 1, wherein dynamically optimizing a sequence of operations comprises obtaining a predefined workflow from a second storage, wherein the predefined workflow is associated with the determined working environment, the determined rule application attribute, or both.

7. The method of claim 1, wherein processing the input data comprises:
pre-processing the input data based on one or more predefined rules;
interpreting the pre-processed data based on the predefined rules; and
post-processing the interpreted data to generate post-processed data.

8. The method of claim 7, wherein pre-processing the input data comprises:
obtaining the input data from a first storage;
formatting the input data;
extracting data based upon the predefined rules; and
computing data based upon the predefined rules.

9. The method of claim 7, wherein interpreting the pre-processed data comprises processing the pre-processed data by an inference engine based on the predefined rules.

10. The method of claim 7, wherein post-processing the interpreted data comprises:
obtaining information associated with system status; and
generating a message indicative of the system status.

11. The method of claim 10, further comprising communicating the generated message to a field service station, a field service technician, or a combination thereof.

12. The method of claim 7, further comprising storing the post-processed data in a third storage.

13. The method of claim 12, further comprising generating a user-viewable representation of the post-processed data, the predefined workflow, the predefined rules, or combinations thereof.

14. A computer readable medium comprising one or more tangible media, wherein the one or more tangible media comprise:
code adapted to determine a working environment, a rule application attribute, or both, wherein the working environment and the rule application attribute are associated with input data;
code adapted to dynamically optimize a sequence of operations based on the determined working environment, the determined rule application attribute, or both; and
code adapted to process the input data based on the optimized sequence of operations.

15. The computer readable medium, as recited in claim 14, wherein code adapted to dynamically optimize a sequence of operations comprises code adapted to obtain a predefined workflow from a second storage, wherein the predefined workflow is associated with the determined working environment, the determined rule application attribute, or both; and

16. The computer readable medium, as recited in claim 14, wherein code adapted to process the input data comprises:
code adapted to pre-process the input data based on one or more predefined rules;
code adapted to interpret the pre-processed data based on the predefined rules; and
code adapted to post-process the interpreted data to generate post-processed data.

17. The computer readable medium, as recited in claim 16, wherein code adapted to pre-process the input data comprises:
code adapted to obtain the input data from a first storage;
code adapted to format the input data;
code adapted to extract data based upon the predefined rules; and
code adapted to compute data based upon the predefined rules.

18. The computer readable medium, as recited in claim 16, wherein code adapted to interpret the pre-processed data comprises code adapted to process the pre-processed data by an inference engine based on the predefined rules.

19. The computer readable medium, as recited in claim 16, wherein code adapted to post-process the interpreted data comprises:
code adapted to obtain information associated with system status; and
code adapted to generate a message indicative of the system status.

20. The computer readable medium, as recited in claim 19, further comprising code adapted to communicate the generated message to a field service station, a field service technician, or a combination thereof.

21. A detection system, comprising:
a workflow module comprising a workflow manager and configured to:
determine a working environment, a rule application attribute, or both, wherein the working environment and the rule application attribute are associated with input data;
dynamically optimizing a sequence of operations based on the determined working environment, the determined rule application attribute, or both;
a processing module configured to process the input data based on the optimized sequence of operations, wherein the processing module comprises:
a pre-processor module configured to pre-process the input data based on one or more predefined rules;
an interpreter module configured to interpret the pre-processed data based on the predefined rules; and
a post-processing module configured to post-process the interpreted data.

22. The system of claim 21, wherein pre-processing module is configured to:
obtain the input data from a first storage;
format the input data;
extract data based upon the predefined rules; and
compute data based upon the predefined rules.

23. The system of claim 22, wherein the interpreter module is configured to process the pre-processed data via an inference engine based on the predefined rules.

24. The system of claim 21, wherein the post-processing module is configured to:
obtain information associated with system status; and
generate a message indicative of the system status.

25. The system of claim 24, wherein the post-processing module is further configured to communicate the generated message to a field service station, a field service technician, or a combination thereof.

26. The system of claim 21, further configured to generate a user-viewable representation of the post-processed data, the predefined workflow, the predefined rules, or combinations thereof.

27. A system, comprising:
a data source, wherein the data source comprises:
an acquisition subsystem configured to acquire data;
a processing subsystem in operative association with the acquisition subsystem and configured to:
process the acquired data;
generate log data;
a data storage subsystem configured to store the log data;
a detection subsystem in operative association with the data storage subsystem and configured to:
determine a working environment, a rule application attribute, or both, wherein the working environment and the rule application attribute are associated with input data;
dynamically optimize a sequence of operations based on the determined working environment, the determined rule application attribute, or both; and
process the log data based on the optimized sequence of operations.

27. The system of claim 26, further configured to generate a user-viewable representation of post-processed data, a predefined workflow, the predefined rules, or combinations thereof.
